(19) United States
(12) Patent Application Publication
(10) Pub. No.: US 2009/0064045 A1
(43) Pub. Date: Mar. 5, 2009

(54) Low memory rendering of graphical objects

(76) Inventor: Christopher Tremblay, Sunnyvale, CA (US)

Correspondence Address: APPLE INC.;c/o Fletcher Yoder, PC, P.O. Box 692289, Houston, TX, 77269-2289, US

(21) Appl. No.: 11/899,166

(22) Filed: Sep. 4, 2007

(51) Int. Cl. G06F 3/048

(52) U.S. Cl. 715/835

(57) ABSTRACT

A method for displaying graphical objects is provided. In one embodiment, the method includes accessing a data structure including a plurality of sequential data objects and the location of associated graphical data stored in a non-volatile storage device. Further, the method may include rendering a first graphical object associated with a first data object of the data structure in a viewport of a device, including loading the graphical data for the first data object from the non-volatile storage into an active memory. The method may also include rendering a second graphical object in the viewport based on the location of the second data object with respect to the first data object within the data structure. In one embodiment, graphical data for data objects is loaded into the active memory on an as-needed basis. Various devices, machine-readable media, and other methods for displaying graphical objects are also provided.

### BACKGROUND

1. Technical Field

The present invention relates generally to image processing and, more particularly, to the display of graphical objects within graphical user interfaces.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices and systems increasingly include display screens as part of the user interface of the device or system. As may be appreciated, display screens may be employed in a wide array of devices and systems, including desktop computer systems, notebook computers, and handheld computing devices, as well as various consumer products, such as cellular phones and portable media players. Such display screens may be useful for displaying status information about the device or for displaying information about an operation being performed by the device. For example, portable music and/or video players may display information about a music or video file being played by the device, such as the title of the song or video being played, the time remaining, the time elapsed, the artist or cast, or other information of interest. Alternatively, the display of such a device may display a piece of artwork or an arbitrary design during operation of the device.

In some instances, it may be desirable to show an image including one or more graphical objects on the display screen, and to allow a user to pan through a relatively large set of such graphical objects. Further, in some cases, the number of graphical objects may exceed that which may be conveniently displayed at one time. In these cases, the display screen may depict only a subset of the total number of graphical objects, and the particular displayed subset may change as a user pans through the total number of graphical objects. Tracking the virtual location of each of these graphical objects with respect to the display screen may consume valuable computing and memory resources in a given device or system and, thus, may be undesirable.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure relates to techniques for displaying graphical objects in a viewport. In accordance with one disclosed embodiment, an exemplary method may include displaying a subset of graphical objects associated with a sequence of data objects, and designating at least one of the graphical objects as a reference object. In one embodiment, the data objects may include information related to music albums and the graphical objects may include cover art for the music albums. Other graphical objects may be considered as being offset from the reference object(s) based on their relative, sequential display position within the sequence of graphical objects. In one embodiment, rather than tracking a virtual position of each graphical object with respect to a display position, only the position of the reference object is tracked. When a new graphical object is to be displayed within the viewport, the memory location of content or data for the graphical object may be accessed from an index or array via the amount of offset of the new graphical object and the reference object, the data may be loaded into active memory, and the new graphical object may be created in the viewport. In some embodiments, data for the graphical objects may be added to and removed from active memory, such as RAM, on an as-needed basis, resulting in lower memory usage and enhanced performance.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of embodiments of the present invention without limitation to the claimed subject matter.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a perspective view illustrating a portable media player in accordance with one embodiment of the present invention;

FIG. 2 is a simplified block diagram of the portable media player of FIG. 1 in accordance with one embodiment of the present invention;

FIG. 3 is a flowchart depicting a process for displaying graphical objects within a viewport of a display in accordance with one embodiment of the present invention;

FIG. 4 illustrates an exemplary viewport including graphical objects that include cover art associated with one or more media files in accordance with one embodiment of the present invention;

FIG. 5 is an exemplary data structure including various data objects, including the location of cover art for the graphical objects to be displayed in the viewport, in accordance with one embodiment of the present invention;

FIG. 6 illustrates a list or table of active albums within the viewport at a given time in accordance with one embodiment of the present invention;

FIG. 7 illustrates the addition and removal of particular albums from the active list of FIG. 6 as a user pans through a portion of the graphical objects in accordance with one embodiment of the present invention;

FIG. 8 depicts the viewport of FIG. 4, in which the graphical objects have generally been shifted to the left by one position in accordance with one embodiment of the present invention;

FIG. 9 illustrates the addition and removal of a plurality of particular albums from the active list of FIG. 6 as a user pans through a portion of the graphical objects in accordance with one embodiment of the present invention; and

FIG. 10 generally depicts the viewport of FIG. 4, in which the graphical objects have been shifted to the left by thirty-one positions in accordance with one embodiment of the present invention.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

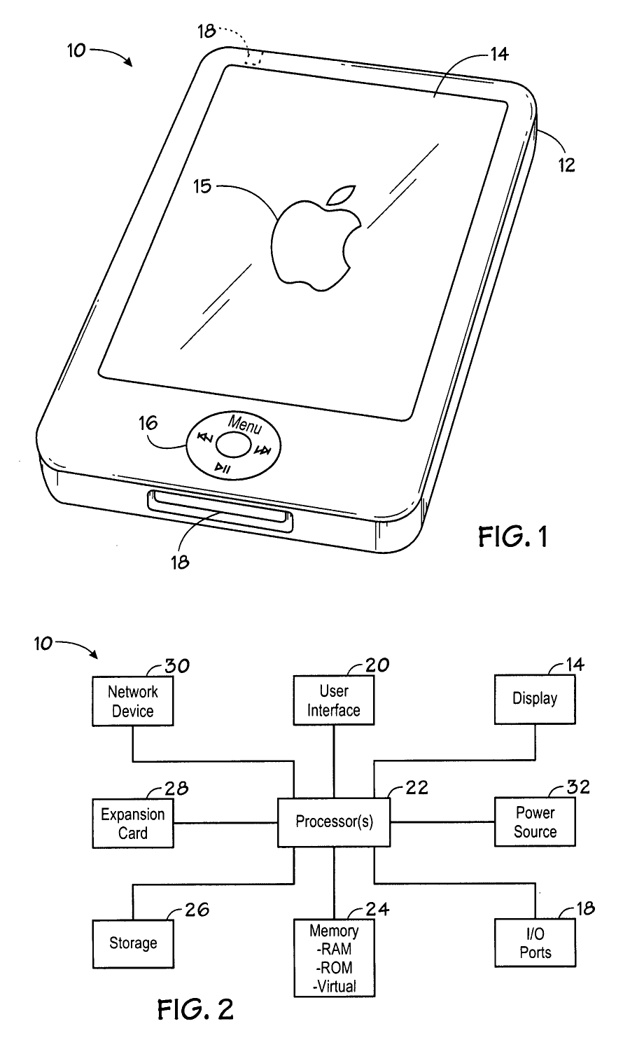

An exemplary electronic device 10 is illustrated in FIG. 1 in accordance with one embodiment of the present invention. In some embodiments, including the presently illustrated embodiment, the device 10 may be a portable electronic device, such as a media player, a cellular phone, a personal data organizer, or the like. Indeed, in such embodiments, a portable electronic device may include a combination of the functionalities of such devices. In addition, the electronic device 10 may allow a user to connect to and communicate through the Internet or through other networks, such as local or wide area networks. For example, the portable electronic device 10 may allow a user to access the internet and to communicate using e-mail, text messaging, instant messaging, or using other forms of electronic communication. By way of example, the electronic device 10 may be a model of an iPod having a display screen or an iPhone available from Apple Inc.

In certain embodiments, the device 10 may be powered by one or more rechargeable and/or replaceable batteries. Such embodiments may be highly portable, allowing a user to carry the electronic device 10 while traveling, working, exercising, and so forth. In this manner, and depending on the functionalities provided by the electronic device 10, a user may listen to music, play games or video, record video or take pictures, place and receive telephone calls, communicate with others, control other devices (e.g., via remote control and/or Bluetooth functionality), and so forth while moving freely with the device 10. In addition, device 10 may be sized such that it fits relatively easily into a pocket or a hand of the user. While certain embodiments of the present invention are described with respect to a portable electronic device, it should be noted that the presently disclosed techniques may be applicable to a wide array of other, less portable, electronic devices and systems that are configured to render graphical data, such as a desktop computer.

In the presently illustrated embodiment, the exemplary device 10 includes an enclosure or housing 12, a display 14, user input structures 16, and input/output connectors 18. The enclosure 12 may be formed from plastic, metal, composite materials, or other suitable materials, or any combination thereof. The enclosure 12 may protect the interior components of the electronic device 10 from physical damage, and may also shield the interior components from electromagnetic interference (EMI).

The display 14 may be a liquid crystal display (LCD), a light emitting diode (LED) based display, an organic light emitting diode (OLED) based display, or some other suitable display. In accordance with certain embodiments of the present invention, the display 14 may display a user interface and various other images, such as logos, avatars, photos, album art, and the like. Additionally, in one embodiment, the display 14 may include a touch screen through which a user may interact with the user interface. The display may also include various function and/or system indicators to provide feedback to a user, such as power status, call status, memory status, or the like. These indicators may be incorporated into the user interface displayed on the display 14.

In one embodiment, one or more of the user input structures 16 are configured to control the device 10, such as by controlling a mode of operation, an output level, an output type, etc. For instance, the user input structures 16 may include a button to turn the device 10 on or off. Further the user input structures 16 may allow a user to interact with the user interface on the display 14. Embodiments of the portable electronic device 10 may include any number of user input structures 16, including buttons, switches, a control pad, a scroll wheel, or any other suitable input structures. The user input structures 16 may work with the user interface displayed on the device 10 to control functions of the device 10 and/or any interfaces or devices connected to or used by the device 10. For example, the user input structures 16 may allow a user to navigate a displayed user interface or to return such a displayed user interface to a default or home screen.

The exemplary device 10 may also include various input and output ports 18 to allow connection of additional devices. For example, a port 18 may be a headphone jack that provides for the connection of headphones. Additionally, a port 18 may have both input/output capabilities to provide for connection of a headset (e.g., a headphone and microphone combination). Embodiments of the present invention may include any number of input and/or output ports, such as headphone and headset jacks, universal serial bus (USB) ports, IEEE-1394 ports, and AC and/or DC power connectors. Further, the device 10 may use the input and output ports to connect to and send or receive data with any other device, such as other portable electronic devices, personal computers, printers, or the like. For example, in one embodiment, the device 10 may connect to a personal computer via an IEEE-1394 connection to send and receive data files, such as media files.

Additional details of the illustrative device 10 may be better understood through reference to FIG. 2, which is a block diagram illustrating various components and features of the device 10 in accordance with one embodiment of the present invention. In the presently illustrated embodiment, the device 10 includes the display 14 and the I/O ports 18 discussed above. In addition, as discussed in greater detail below, the exemplary device 10 may include a user interface 20, one or more processors 22, a memory device 24, a non-volatile storage 26, card interface(s) 28, a networking device 30, and a power source 32.

As discussed further herein, the user interface 20 may be displayed on the display 14, and may provide a means for a user to interact with the electronic device 10. The user interface may be a textual user interface, a graphical user interface (GUI), or any combination thereof, and may include various layers, windows, screens, templates, elements, or other components that may be displayed in all or in part of the display 14. The user interface 20 may, in certain embodiments, allow a user to interface with displayed interface elements via one or more user input structures 16 and/or via a touch sensitive implementation of the display 14. In such embodiments, the user interface provides interactive functionality, allowing a user to select, by touch screen or other input structure, from among options displayed on the display 14. Thus the user can operate the device 10 by appropriate interaction with the user interface 20.

The processor(s) 22 may provide the processing capability required to execute the operating system, programs, user interface 20, and any other functions of the device 10. The processor(s) 22 may include one or more microprocessors, such as one or more “general-purpose” microprocessors, one or more special-purpose microprocessors and/or ASICS, or some combination thereof. For example, the processor 22 may include one or more reduced instruction set (RISC) processors, such as a RISC processor manufactured by Samsung, as well as graphics processors, video processors, and/or related chip sets.

As noted above, embodiments of the electronic device 10 may also include a memory 24. The memory 24 may include a volatile memory, such as random access memory (RAM), and/or a non-volatile memory, such as read-only memory (ROM) or a virtual memory in a hard drive or other storage medium. The memory 24 may store a variety of information and may be used for various purposes. For example, the memory 24 may store the firmware for the device 10, such as an operating system, other programs that enable various functions of the device 10, user interface functions, processor functions, and may be used for buffering or caching during operation of the device 10.

The non-volatile storage 26 of device 10 of the presently illustrated embodiment may include ROM, flash memory, a hard drive, or any other suitable optical, magnetic, or solid-state storage medium, or a combination thereof. The storage 26 may store data files such as media (e.g., music and video files), software (e.g., for implementing functions on device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable the device 10 to establish a wireless connection, such as a telephone connection), subscription information (e.g., information that maintains a record of podcasts, television shows, or other media to which a user subscribes), telephone information (e.g., telephone numbers), and any other suitable data.

The embodiment illustrated in FIG. 2 also includes one or more card slots 28. The card slots may be configured to receive expansion cards that may be used to add functionality to the device 10, such as additional memory, I/O functionality, or networking capability. Such an expansion card may connect to the device through any type of suitable connector, and may be accessed internally or external to the enclosure 12. For example, in one embodiment, the card may be flash memory card, such as a SecureDigital (SD) card, mini- or microSD, CompactFlash card, Multimedia card (MMC), or the like. Additionally, in an embodiment including mobile telephone functionality, a card slot 28 may receive a Subscriber Identity Module (SIM) card.

The exemplary device 10 depicted in FIG. 2 also includes a network device 30, such as a network controller or a network interface card (NIC). In one embodiment, the network device 30 may be a wireless NIC providing wireless connectivity over any 802.11 standard or any other suitable wireless networking standard. The network device 30 may allow the device 10 to communicate over a network, such as a LAN, WAN, MAN, or the Internet. Further, the device 10 may connect to and send or receive data with any device on the network, such as portable electronic devices, personal computers, printers, and so forth. For example, in one embodiment, the device 10 may connect to a personal computer via the network device 30 to send and receive data files, such as media files. Alternatively, in some embodiments, the portable electronic device may not include a network device 30. In such an embodiment, a NIC may be added into card slot 28 to provide similar networking capability as described above.

Further, the device 10 may also include a power source 32. In one embodiment, the power source 32 may be one or more batteries, such as a Li-Ion battery, may be user-removable or secured to the housing 12, and may or may not be rechargeable. Additionally, the power source 32 may include AC power, such as provided by an electrical outlet, and the device 10 may be connected to the power source 32 via the I/O ports 18.

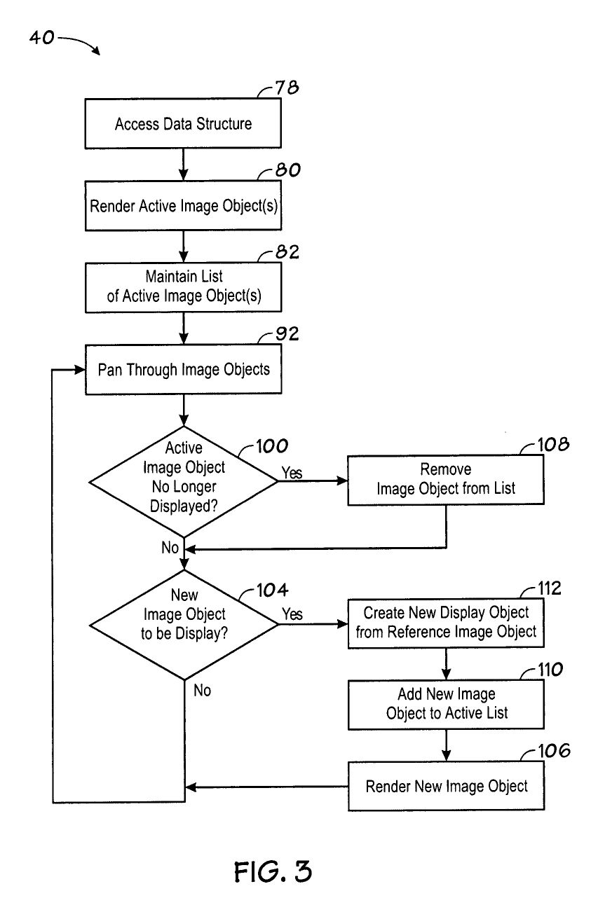

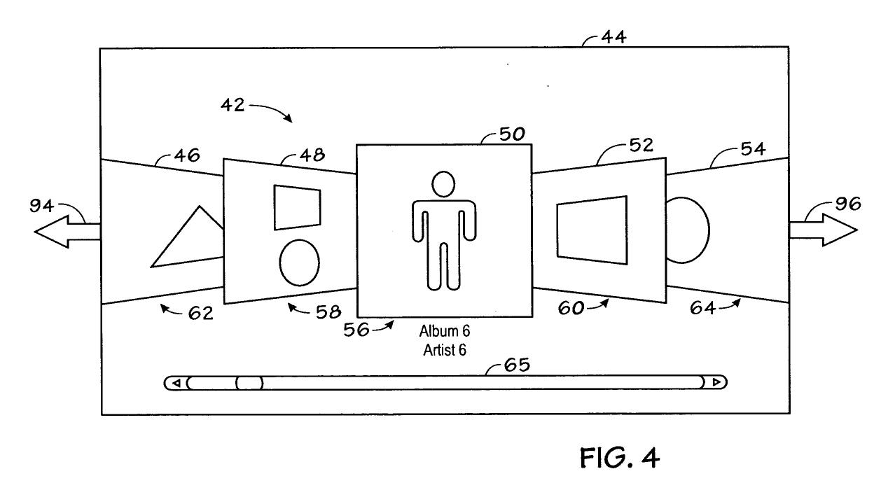

It should again be noted that the device 10 may be configured to display various images and data. Particularly, in one embodiment, the device 10 may be configured to execute various instructions for carrying out display processes. Turning now to FIG. 3, a flow chart for an exemplary display process or method 40 is provided. Various aspects of the method 40 may be better understood with reference to FIGS. 4-10. Accordingly, for the sake of clarity, aspects of the exemplary method 40 are discussed below in parallel with discussion of various features depicted in FIGS. 4-10.

In some embodiments, the exemplary method 40 facilitates the display of image or graphical objects 42 within a viewport 44 of a display, such as the display 14. In one embodiment, the graphical objects 42 may include representations of cover art for various media, such as cover art for music albums, movies, television shows, books, and so forth, for instance. It should be noted, however, that the graphical objects 42 may also include, or consist entirely of, other images, such as photos, icons, avatars, and other such items, in full accordance with the present techniques. In one embodiment, the viewport 44 may be configured to display a certain number of graphical objects 42. For instance, in the presently illustrated embodiment, the viewport 44 is generally configured to display five graphical objects 42, although a greater or lesser number of such objects, including a single object, may be displayed in other embodiments.

In the presently illustrated embodiment, the graphical objects 42 that are displayed in the viewport 44 include individual or particular graphical objects 46, 48, 50, 52, and 54. Further, each of these displayed graphical objects may be considered to be in a particular display position within the viewport 44. For instance, the graphical object 50 may be considered to be displayed in a center position 56. Further, the graphical objects 48 and 52 may be considered to be in display positions 58 and 60, which may be considered to be offset from the center position 56 by one position. Likewise, the graphical objects 46 and 54 may be displayed in positions 62 and 64 of the viewport 44, and may be considered to be two positions offset from the center position 56. In some embodiments, the displayed graphical objects 46, 48, 50, 52, and 54 may be a subset of a greater number of graphical objects 42. Though not actually displayed in the viewport, any non-displayed graphical objects 42 may be considered as having virtual display positions outside the area of the viewport 44 and offset by a respective number of positions from the center position 56. In other words, a number of graphical objects may be ordered in a list, where only a subset of the ordered list of graphical objects are displayed at any given time such that graphical objects on the list before and after the displayed subset constitute non-displayed graphical objects.

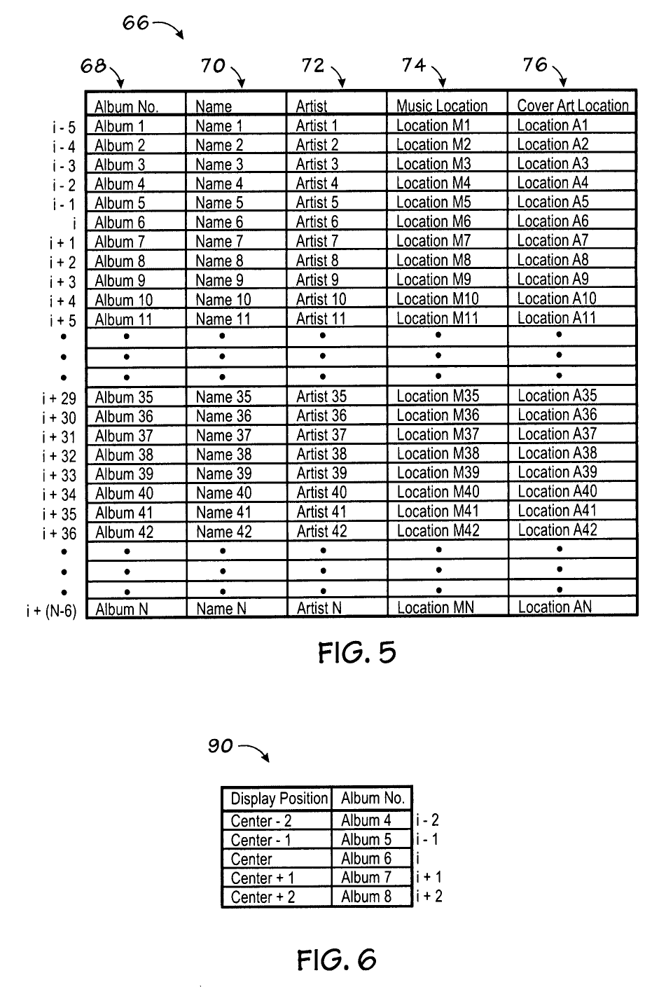

Additionally, in some embodiments, in addition to cover art and/or other images, each graphical object 42 may be associated with additional data objects, and such associations may be stored in a data structure, such as the array 66 illustrated in FIG. 5. The exemplary array 66 includes a sequential list 68 of audio albums, and may also include additional data for each album such as song names 70, artists 72, and the memory locations 74 and 76 of audio files and cover art, respectively, corresponding to a particular album 68. It will be appreciated that, in other embodiments, the array 66 may include other data in addition to, or instead of, that indicated in FIG. 5. In some embodiments, the exemplary method 40 may include accessing the array 66 and rendering or creating (i.e., causing to be displayed) one or more graphical objects 42 within the viewport 44, generally corresponding to blocks 78 and 80 of FIG. 3. Further, although a particular array 66 is provided herein for illustrative purposes, it should be noted that other suitable data structures may used in full accordance with the present techniques.

In some embodiments, the subset of graphical objects 42 that are displayed on the viewport 44 may be considered to be “active” image or graphical objects, and a list of such active image objects and/or their corresponding albums, along with their display position, may be maintained (block 82 of FIG. 3), as generally provided in FIG. 6. In one embodiment related to a media player, an exemplary list or table 90 includes an association between the display positions of the viewport 44 and the albums or files currently associated with the graphical objects 42 in each position. For instance, in the presently illustrated embodiment, the graphical object 50 in the center position 56 may include the cover art for Album No. 6 of the array 66, and Album No. 6 may be associated with the center position 56. Similarly, the graphical objects 46, 48, 52, and 54 may include cover art for Album Nos. 4, 5, 7, and 8, respectively, which may be respectively associated with the other display positions within the viewport.

In one embodiment, the exemplary method 40 includes panning or scrolling (block 92) through the graphical objects 42 associated with the albums or other data objects of the array 66 using the scroll bar 65. Such panning may include animating the graphical objects 42 to simulate motion of these objects within, into, and out of the viewport 44, such as generally indicated by the arrows 94 and 96 in FIG. 4. Although the arrows 94 and 96 generally indicate horizontal movement of the graphical objects 42, it will be appreciated that the graphical objects 42 may be animated in other directions if desired. Further, in various embodiments, such panning and/or animation may be commenced upon user input or automatically.

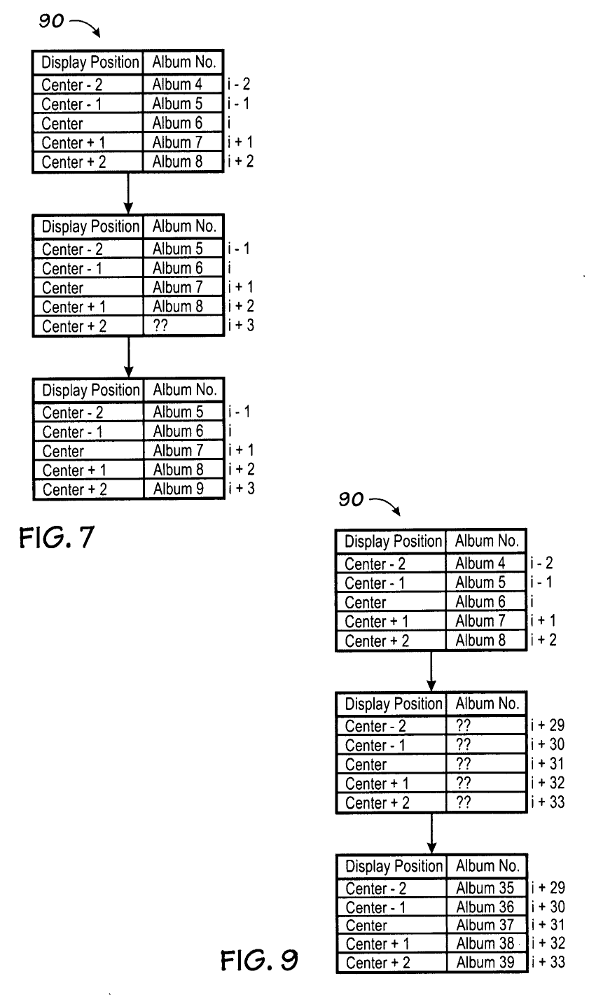

In some embodiments, particular graphical objects 42 may be added and/or removed from the viewport 44 based on the panning through the graphical objects 42, and the table 90 of active albums may be updated based on such panning, as generally illustrated in FIGS. 7-10. For example, the displayed graphical objects 42 of FIG. 4 may undergo simulated motion in the direction indicated by the arrow 94 to result in the illustration of viewport 44 in FIG. 8. Particularly, in one embodiment, as the individual graphical objects 46, 48, 50, 52, and 54 move to the left with respect to the viewport 44, the graphical object 46 may no longer be visible in the viewport 44 (block 100 of FIG. 3), while the graphical objects 48, 50, 52, and 54 each move over one position (i.e., to the positions 62, 58, 56, and 60, respectively). Additionally, a new active graphical object 102, corresponding to Album No. 9 in the presently illustrated embodiment, may be displayed (blocks 104 and 106 of FIG. 3) in the position 64 of the viewport 44. Further, the table 90 of active albums may be updated in view of the addition and the removal of various graphical objects 42 from the viewport 44, as generally illustrated in FIG. 7 (blocks 108 and 110 of FIG. 3). Particularly, as the graphical objects 42 shift to the left, Album No. 4 may be removed from the list, Album Nos. 5-8 may be moved over one display position, and Album No. 9 may be added to the table 90, corresponding to the movement of the display objects 42 between the illustrated viewports 44 of FIGS. 4 and 8.

Notably, in some embodiments, new graphical objects 42, such as an individual graphical object 102, may be generated or created (block 112 of FIG. 3) from some other graphical object 42 and displayed in the viewport 44. For example, in some embodiments, a displayed graphical object 42 may be considered a reference object and all other graphical objects 42 may be described as offset by some amount from the reference object. In the presently illustrated embodiment of FIGS. 4-6, the graphical object 50 in the center position 56 may be considered to be the reference object at a generic position i, and every other graphical object 42 may be considered to be in a position offset from i by some integer (e.g., i−1, i−2, i−3, etc., or i+1, i+2, i+3, etc.), as generally indicated in FIG. 5.

As the viewport pans from the image of FIG. 4 to that of FIG. 8, the graphical object 46 associated with Album No. 4 is removed from the viewport 44 and from the list 90 of active albums, as generally indicated in FIG. 7. As the graphical objects 42 shift to the left in the viewport 44, an additional graphical object 42, such as individual graphical object 102, may be displayed in the viewport 44 in the position 64. In one embodiment, the newly displayed graphical object 102 is created from the reference object, such as the graphical object 50, by determining the offset of the vacant display position from the position of the reference object and accessing the appropriate data from the array 66 based on the magnitude of this offset. For example, as illustrated in FIG. 7, the vacant display position 64 is three positions away (i.e., the i+3 position) from the position (i) of the reference object 50 (Album No. 6). The array 66 may then be searched for data related to the album (e.g., Album No. 9) that is offset by a corresponding amount (i+3) to retrieve the memory location of the cover art for the particular graphical object 102, add the active album to the table 90, and display the graphical object 102 within the viewport 44.

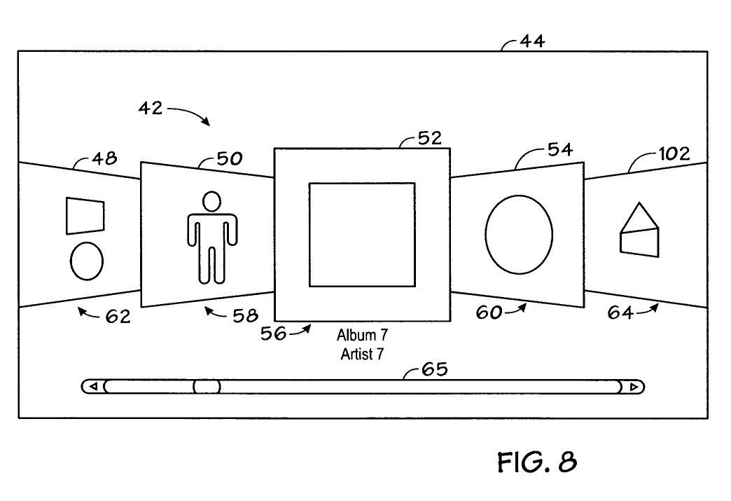

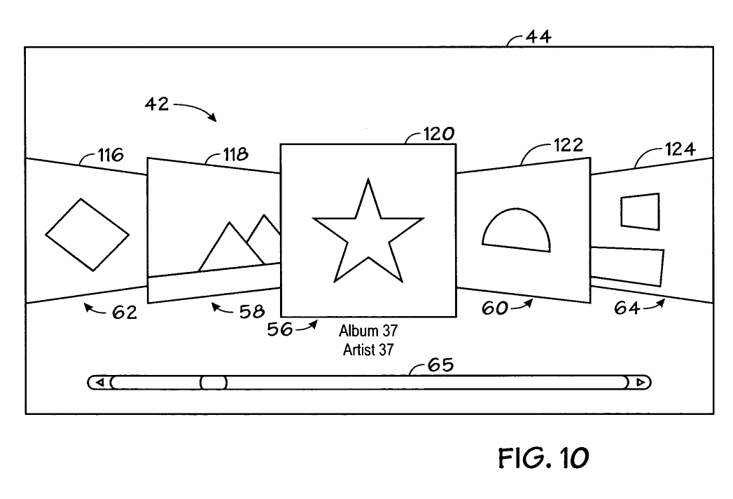

Further, the above techniques may be applied to generate a plurality of newly displayed image objects, such as when all of the displayed graphical objects 42 are panned out of the viewport 44. For example, in the embodiment illustrated in FIGS. 9 and 10, the individual graphical objects 42 displayed in the viewport 44 of FIG. 4 are panned out of the viewport and replaced by additional graphical objects 116, 118, 120, 122, and 124, which may include cover art for Album Nos. 35-39, respectively. Particularly, in this embodiment, a reference object, such as graphical object 50 (position i), may be tracked out of the viewport 44, the particular albums or graphical objects to display in the viewport may be extrapolated from the reference object based on the panning rate (positions i+29, i+30, i+31, i+32, and i+33) and the newly-displayed graphical objects 116, 118, 120, 122, and 124 may be created from the reference object in a manner similar to that described above with respect to FIGS. 4-8.

It should be noted that, in some embodiments, the panning rate may vary automatically or in response to user input. Further, in some embodiments, the panning rate may be comparatively high and the cover art of particular albums (or the graphical data of other graphical objects) may not be displayed until the panning rate falls below a threshold level. For instance, the panning from Album Nos. 4-8 to Album Nos. 35-39 may be at such a fast speed that displaying of the cover art for each of intermediate Album Nos. 9-4, as they track from right to left across the viewport 44, may be undesirable (e.g., due to memory and/or processing constraints, aesthetic reasons, or the like). In such embodiments, a generic image may be displayed for some or all of the intermediate albums until the panning rate falls to a certain level.

For instance, to reduce resource consumption, as Album Nos. 9-34 pan through the various display positions of the viewport 44, these albums may be represented as generic images rather than with the cover art for each of these intermediate albums. Once the panning speed is such that sufficient memory and/or other resources are available, the particular cover art for each displayed album may again be rendered. In other embodiments, it may be desirable to display the cover art for each intermediate album when it is in the center display position of the viewport 44, and to use a generic image for each album outside of the center display position, such as when a given device 10 has sufficient memory and processing resources (at a given panning rate) to display the actual cover art for only a portion of the animated albums. Additionally, in some embodiments, the device 10 may be configured to decide between displaying the actual cover art or a generic image for each album based on the panning rate and/or available computing resources.

Notably, the presently described embodiments may also facilitate reduced usage of memory and/or processing resources in a given device having an active memory, such as the RAM and/or the virtual memory of the memory 24 described above, and a storage medium, such as non-volatile storage 26 of the device 10. Particularly, in some embodiments, graphical data for the individual image objects may be loaded into the RAM and/or the virtual memory, from the non-volatile storage 26, on an as-needed basis, rather than having all graphical data for each image object loaded into the RAM and/or the virtual memory. For instance, in one embodiment, graphical data for the active image objects corresponding to the active albums of table 90 may be the only graphical data loaded into the RAM. In other embodiments, the direction and rate of panning through the plurality of graphical objects 42 may be used to predict the next graphical objects 42 likely to be displayed, and the graphical data for the expected renderings of those predicted graphical objects 42 may also be loaded into the RAM and/or virtual memory. Additionally, the location of the desired graphical data may be accessed via the array 66 of FIG. 5. Once the graphical data of a particular image object 42 is no longer needed for rendering (or expected rendering for an image object predicted to be displayed), the graphical data of the image object 42 may be removed from the RAM and/or virtual memory. Thus, in some embodiments, the creation or rendering of additional display objects 42 within the viewport 44 may be performed without tracking the location of each image object, and may allow a subset of the graphical objects 42 to be the only graphical objects stored in active memory, such as the RAM and/or virtual memory of the device 10. Accordingly, the presently described embodiments may facilitate reduced usage of memory and processing resources in a given device.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method comprising:
accessing a data structure including a plurality of sequential data objects and the location of respective graphical data associated with the sequential data objects, wherein the graphical data for each data object of the plurality of sequential data objects is stored within a non-volatile storage device;
rendering within a viewport a first graphical object associated with a first data object selected from the plurality of sequential data objects, wherein rendering the first graphical object comprises loading the graphical data associated with the first data object from the non-volatile storage device to an active memory; and
rendering within the viewport a second graphical object associated with a second data object, wherein rendering the second graphical object comprises loading the graphical data associated with the second data object from the non-volatile storage device to the active memory, and is based at least in part on the relative sequential location of the second data object with respect to the first data object within the data structure;
wherein the active memory only contains a subset of the graphical data associated with the plurality of sequential data objects.

2. The method of claim 1, wherein the data structure comprises an array.

3. The method of claim 1, wherein the data structure comprises data relating to at least one of a plurality of audio files or a plurality of video files.

4. The method of claim 3, wherein the respective graphical objects comprise cover art associated with at least one of the plurality of audio files or the plurality of video files.

5. The method of claim 1, wherein one or more respective graphical objects are displayed in sequential order within a portion of the viewport, and the second graphical object is rendered within the portion upon a determination of sufficient area within the portion.

6. The method of claim 5, comprising:
tracking at least one of the one or more graphical objects displayed within the portion of the viewport or one or more of the data objects associated with the one or more graphical objects, the one or more graphical objects comprising the first graphical object;
animating the one or more graphical objects; and
rendering the second graphical object in an area of the portion vacated by at least one of the one or more graphical objects during the animation of the one or more graphical objects, wherein the graphical data associated with the second graphical object is loaded into the active memory on an as-needed basis.

7. The method of claim 6, wherein the second data object is not separated from the one or more data objects by any additional data object within the data structure.

8. An electronic device comprising:
a housing;
a display disposed in the housing;
at least one memory device disposed in the housing, the at least one memory device including executable application instructions stored therein; and
a processor disposed in the housing and configured to execute the application instructions stored in the at least one memory device;
wherein the electronic device is configured to display a subset of image objects of a plurality of image objects arranged in a sequential order, and to animate the subset of image objects such that a user may pan through the ordered plurality of image objects, wherein particular image objects are added to and removed from the subset of image objects and comprise at least one image object to be added to the subset that is created from a reference image object.

9. The electronic device of claim 8, wherein the plurality of image objects comprises images associated with at least one of music files or video files.

10. The electronic device of claim 9, wherein the plurality of image objects comprises a plurality of cover art images.

11. The electronic device of claim 8, wherein creating the at least one image object to be added from a reference image object comprises determining the offset of the at least one image object to be added with respect to the reference image object and retrieving graphical data for the at least one image object based on the offset.

12. The electronic device of claim 11, wherein retrieving the graphical data comprises searching an index including the memory location of graphical data for the plurality of image objects.

13. The device of claim 8, wherein the device comprises a portable media player.

14. The device of claim 8, wherein the device is configured to enable a user to pan through the ordered plurality of image objects without tracking each of the image objects of the ordered plurality of image objects.

15. A method for operating a media player, the method comprising:
storing a plurality of media files and associated cover art in a memory of the media player;
displaying the cover art associated with one or more media files of the plurality of media files in a viewport; and
panning through the cover art of the plurality of media files, wherein an additional cover art object of the associated cover art is displayed as a result of panning through the cover art and is generated from an earlier-displayed cover art object.

16. The method of claim 15, wherein the panning is performed in response to a user input.

17. The method of claim 15, wherein the earlier-displayed cover art object and the additional cover art object are displayed within the viewport simultaneously.

18. The method of claim 15, wherein the earlier-displayed cover art object is removed from the viewport prior to display of the additional cover art object.

19. The method of claim 15, wherein generating the additional cover art object is performed through reference to a data array comprising a sequential listing of the plurality of media files and the memory locations of the associated cover art.

20. One or more tangible, machine-readable media having application instructions encoded thereon, the application instructions comprising:
instructions for accessing a plurality of sequential image objects and associated graphical data from a non-volatile storage;
instructions for displaying a first image object in a viewport of a display;
instructions for determining that the viewport has sufficient available area to display a second image object;
instructions for determining the sequential distance between the first and second image objects;
instructions for retrieving the graphical data of the second image object from the non-volatile storage based on the sequential distance and loading the graphical data of the second image object into an active memory; and
instructions for displaying the second image object.

21. The one or more tangible, machine-readable media of claim 20, wherein the instructions for retrieving the graphical data of the second image object comprise instructions for searching a data array based on the sequential distance to find the memory location of the graphical data.

22. The one or more tangible, machine-readable media of claim 20, wherein the application instructions comprise instructions for loading the graphical data for particular image objects into the active memory on an as-needed basis.

23. The one or more tangible, machine-readable media of claim 22, wherein the instructions for loading the graphical data for particular image objects into the active memory on an as-needed basis comprise instructions for loading only the graphical data associated with image objects that are displayed in the viewport.

24. The one or more tangible, machine-readable media of claim 20, wherein the one or more tangible, machine-readable media comprises a flash memory device.

25. The one or more tangible, machine-readable media of claim 20, wherein the one or more tangible, machine-readable media comprises a hard disk drive.
